(19) United States
(12) Patent Application Publication
(10) Pub. No.: US 2024/0102662 A1
(43) Pub. Date: Mar. 28, 2024

(54) FOOD PREPARATION SYSTEM

(71) Applicant: BSH Hausgeräte GmbH, Munich (DE)

(72) Inventors: Carlos Franco Gutierrez, Zaragoza (ES); Teresa Del Carmen Marzo Alvarez, Zaragoza (ES); Maria Parra Borderías, Zaragoza (ES)

(21) Appl. No.: 17/768,502

(22) PCT Filed: Oct. 20, 2020
(86) PCT No.: PCT/EP2020/079491

§ 371 Date: Apr. 13, 2022

(30) Foreign Application Priority Data
Oct. 30, 2019 (EP) 19382947.0

(51) Int. Cl. F24C 7/08

(52) U.S. Cl. CPC F24C 7/083

(57) ABSTRACT

A food preparation system includes a control unit which is designed to guide through a process step of a process, which is in the form of a recipe and comprises the process step in the form of a recipe step. The control unit is further designed to guide at least temporarily simultaneously to the process step at least one further process step, which is in the form of a recipe step.

The invention relates to a food preparation system as claimed in the preamble of claim 1 and a method for an operation of a food preparation system as claimed in the preamble of claim 15.

A food preparation system which has an output unit and a control unit is already known from the prior art. In an operating state, the control unit guides through a process step of a process via the output unit. The process in this case is in the form of a recipe and comprises the process step which is in the form of a recipe step. During the guidance through the process, the control unit guides through each process step individually and outputs each process step individually via the output unit. During the guidance through the process, the control unit guides through a further process step which is different from the process step, always chronologically separately from the guidance through the process step.

The object of the invention, in particular but not limited thereto, is to provide a generic system having improved properties in terms of ease of use. The object is achieved according to the invention by the features of claims 1 and 15, while advantageous embodiments and developments of the invention may be derived from the subclaims.

The invention is based on a food preparation system, in particular having at least one output unit and having at least one control unit designed, in particular, to control and/or regulate the output unit and designed to guide through at least one process step of at least one process, which is in the form of a recipe and comprises the process step in the form of a recipe step, in particular via the output unit.

It is proposed that the control unit is designed to guide at least temporarily simultaneously through the process step and at least one further process step, which is in the form of a recipe step.

In particular, a high level of ease of use may be achieved by means of such an embodiment. In particular, a particularly rapid and/or time-saving guidance through the process may be provided, whereby a rapid guidance through the recipe and/or a high level of ease of use may be achieved, in particular in the case of at least one time-consuming and/or complex process and/or in the case of an integration of at least one household appliance which is different from the cooking appliance. In particular, even very complex and/or extensive processes may be offered to a user for selection, since in particular a high potential for saving time may be provided by the guidance through at least two process steps which is at least temporarily simultaneous. In particular, a high level of flexibility may be achieved, in particular relative to a number of possible processes to be selected and/or relative to a guidance through the process. Advantageously, by means of the guidance through the process, in particular, a particularly simple preparation of food may be possible, since in particular at least some of the process steps of the process may run at least partially automatically and/or at least temporarily simultaneously.

A “food preparation system” is intended to be understood to mean, in particular, a system which has at least one functional unit, the main function thereof being a preparation of at least one food, and which in particular could also have at least one further functional unit, the main function thereof deviating from a preparation of at least one food. For example, the functional unit could be a cooking appliance and advantageously a cooktop, the main function thereof being in particular a preparation of at least one food. In an operating state, the functional unit heats and/or warms up and/or cooks, in particular, at least one food and namely, in particular, for the purpose of a preparation of the food.

In particular, in an operating state, the functional unit executes at least one cooking appliance main function. In particular, the functional unit is part of a cooking appliance and in an operating state executes, in particular, the cooking appliance main function of the cooking appliance. In an operating state, the functional unit could execute, for example, at least one heating function and/or at least one cooking function. The food preparation system has, in particular, at least one and advantageously at least the cooking appliance.

The cooking appliance could be configured, for example, as an oven, such as for example as a baking oven and/or as a cooker. An “oven” is intended to be understood to mean, in particular, a cooking appliance which has at least one muffle which at least partially delimits and/or defines at least one cooking chamber and which in an operating state supplies energy to at least one food, in particular for the purpose of heating and/or cooking the food, in particular in the cooking chamber. For example, the cooking appliance could be in the form of a microwave and/or a grill appliance and/or a steamer. Advantageously, the cooking appliance is in the form of a cooktop. The cooking appliance is in the form of, in particular, an induction cooking appliance.

In particular, in an operating state, the further functional unit executes at least one appliance main function. In particular, the further functional unit is part of an electrical appliance and in an operating state executes, in particular, an appliance main function of the electrical appliance. For example, in an operating state, the further functional unit could execute at least one refrigerating function and/or at least one freezing function and/or at least one processing function and/or at least one scaling function and/or at least one cleaning function and/or at least one drying function. For example, in an operating state, the further functional unit could process and, in particular, comminute and/or chop and/or stir and/or knead and/or blend and/or mix and/or cut up at least one food by means of the processing function.

The food preparation system has, in particular, at least one electrical appliance and advantageously at least the electrical appliance. The electrical appliance could be, for example, a mobile device and/or a household appliance, in particular a refrigeration appliance and/or a scaling appliance and/or a processing appliance. The scaling appliance could be, in particular, weighing scales, in particular kitchen scales. The processing appliance could be, in particular, a kneading machine and/or a dough machine and/or a mixer and/or a mixing machine.

The food preparation system differs, in particular, from a cookbook which is stored on a data carrier and/or which is able to be played back in at least one playback appliance, such as for example a DVD player. During the guidance through the recipe, the control unit in particular executes actions and/or handling operations which go beyond a simple playback of stored data and calculates, in particular actively, at least one further action and/or at least one further handling operation. In an operating state, the control unit is designed, in particular, to react to at least one user input and/or to change at least one process and/or at least one process step of the process, in particular as a function of at least one user input. “To change” is intended to be understood to mean, in particular, to edit and/or to modify and/or to alter and/or to delete and/or to skip and/or to add.

An “output unit” is intended to be understood to mean, in particular, a unit which is designed to provide a user with at least one variable, in particular optically and/or acoustically and/or haptically. The provided variable could be, for example, information and/or a time specification and/or an operating request and/or a handling request and/or a selection. The output unit could be designed, in particular, to output at least one acoustic signal and/or in particular at least one acoustic sequence, such as for example a ring tone and/or a warning signal and/or a request, in particular in the form of a pre-produced sentence. Alternatively or additionally, the output unit could be designed to provide at least one optical output, such as for example a display of at least one image and/or at least one text and/or at least one number and/or at least one animation. For example, the output unit could have at least one loudspeaker. Alternatively or additionally, the output unit could have a display unit, in particular with at least one lighting means, advantageously an LED, and/or in particular a back-lit display, in particular a matrix display and/or an LCD display, an OLED display and/or electronic paper. Advantageously, the output unit could have at least one liquid crystal display.

By a combination of the output unit, which in particular has at least one liquid crystal display, and a guidance through the process and, in particular, a connection of the cooking appliance to the household appliance, in particular the advantages of a product, in particular of the cooking appliance and/or the household appliance, may be exploited, whereby in particular a high level of brand loyalty and/or product loyalty of a user could be achieved.

The food preparation system has, in particular, at least one user interface which is designed, in particular, for an input and/or output of operating parameters. The user interface and the output unit are configured, in particular, at least partially integrally and advantageously integrally. Advantageously, the user interface comprises the output unit. “Integrally” is intended to be understood to mean, in particular, at least connected by a material connection, for example by a welding process, an adhesive bonding process, an injection-molding process and/or a further process which appears expedient to the person skilled in the art and/or advantageously formed in one piece, such as for example by a production from a casting and/or by a production in a single-component or multi-component injection-molding method and advantageously from a single blank.

A “control unit” is intended to be understood to mean, in particular, an electronic unit which is preferably designed to control and/or regulate at least the output unit and/or the user interface. The control unit could be at least partially integrated, for example, in a control and/or regulating unit of at least one cooking appliance and advantageously of a cooktop and could be designed, in particular, to control and/or regulate at least one functional unit of the cooking appliance which could be designed, in particular, for carrying out a cooking appliance main function, in particular of the cooking appliance. In particular, the control unit has a computing unit and, in particular in addition to the computing unit, at least one memory unit with a control and/or regulating program which is stored therein and which is designed to be executed by the computing unit.

A “process” is intended to be understood to mean, in particular, a chronological sequence of settings and/or actions and/or computing operations, in particular for achieving at least one defined result. The settings could comprise, for example, heat settings and/or other operating settings and/or handling requests and/or process steps. For example, the actions could be executed and/or at least initiated by the control unit. The control unit could be designed, in particular, to execute and/or at least to initiate at least one action and/or at least one computing operation, in particular in order to achieve the defined result. For example, the result could be predefined and, in particular, stored in the memory unit of the control unit. For example, the result could be predetermined, in particular alternatively or additionally, by at least one user input, in particular by means of the user interface. In an operating state, the control unit could output, in particular, at least one operating request and execute and/or at least initiate at least one action and/or at least one computing operation, in particular as a function of at least one user input, in particular by means of the user interface.

The expression that the control unit “at least initiates” an action is intended to be understood to mean, in particular, that the control unit executes the action itself and/or that the control unit initiates the action. The expression that the control unit “initiates” an action is intended to be understood to mean, in particular, that the control unit activates at least one further unit which executes the action as a function of the activation by the control unit.

In particular, the process could have at least two, in particular at least three, advantageously at least four, particularly advantageously at least five, preferably at least six and particularly preferably a plurality of process steps. For example, in particular at least two, advantageously at least three, particularly advantageously at least five, preferably at least eight and particularly preferably a plurality of different processes could be stored in the memory unit of the control unit.

The process could comprise, for example, at least one provision of information and/or at least one information search and/or at least one preparing process, in particular a food preparing process, and/or at least one processing process, in particular at least one food processing process and/or at least one preparation process, in particular at least one food preparation process, and/or be configured as such. Particularly advantageously, the process comprises a recipe and is, in particular, in the form of a recipe.

A “process step” is intended to be understood to mean, in particular, a subsection of a process which has, in particular, a defined time duration and, in particular, a defined method step. The method step could comprise, for example, at least one heating step and/or at least one step with an interaction via the output unit and/or at least one step with an interaction via the user interface. For example, the method step could comprise at least one processing of at least one food and/or at least one preparing of at least one food. The time duration of the process step could be fixedly predetermined and/or variable, for example. For example, the time duration of the process step could be dependent on a time duration which is required for a user input, in particular by means of the user interface.

For example, the process step could comprise at least one information step and/or at least one comparison step and/or at least one analysis step and/or at least one instruction step and/or at least one research step and, in particular, be configured as such. The process step which is in the form of, in particular, a recipe step could comprise for example, alternatively or additionally, in particular at least one heating step and/or at least one cooking step and/or at least one food preparing step and/or at least one food addition step and/or at least one food removal step and/or at least one food processing step and/or at least one preparing step and/or be configured as such.

A “recipe” is intended to be understood to mean, in particular, a chronological sequence of heat settings and/or other operating settings and/or handling requests and/or recipe steps for a preparation of at least one food. The heat settings could comprise, for example, at least one heating duration and/or at least one heating power and/or at least one heating temperature and/or at least one heating type, such as for example frying and/or boiling and/or steaming and/or simmering and/or melting and/or pressure cooking, in particular in a pressure cooker, and/or deep-frying and/or sautéing and/or poaching and/or baking and/or grilling. The operating settings could comprise, for example, at least one time duration which defines a total duration of the recipe, for example, and/or at least a chronological sequence of recipe steps and/or at least one type of output via the output unit, such as for example optically and/or acoustically. The recipe could be in the form of, in particular, a cooking recipe and/or a food preparation recipe.

In an operating state, the control unit guides in particular through at least one, in particular selected, process and namely, in particular, as a function of a selection of the process by at least one user input, in particular by means of the user interface. The expression that the control unit is designed to “guide” through at least one process step of at least one process is intended to be understood to mean, in particular, that in an operating state the control unit requests at least one handling operation and/or outputs at least one piece of information, in particular by means of at least one output via the output unit and/or via the user interface, and/or that in an operating state the control unit automatically undertakes and/or initiates process steps required for carrying out the process. “Automatically” is intended to be understood to mean, in particular, by itself and/or avoiding an interaction by means of the user interface and/or avoiding a handling operation of a user.

The process step and the further process step are, in particular, in the form of process steps which are independent of one another and/or process steps which are separate and/or discrete and/or distinct from one another. For example, the process step and the further process step could be of the same type. The process step and the further process step could be, for example, of a different type. In particular, the process step and the further process step are able to be executed independently of one another. The process step and the further process step, in particular, do not overlap in terms of content. Advantageously, the process step and the further process step are able to be executed in any chronological relation to one another, and namely in particular by avoiding influencing the result to be achieved and/or by achieving the same result.

The expression that the control unit is designed to guide “at least temporarily simultaneously” through the process step and at least one further process step, is intended to be understood to mean, in particular, that in an operating state the control unit guides simultaneously through at least one subsection of the process step and through at least one subsection of the further process step, wherein in an operating state the control unit, in particular additionally, could for example guide through at least one further subsection of the process step without chronologically overlapping the further process step and/or through at least one further subsection of the further process step without chronologically overlapping the process step.

In particular, the process step has at least one subsection through which in an operating state the control unit guides, chronologically overlapping at least one subsection of the further process step. The process step could have, for example, at least one further subsection through which in an operating state the control unit could guide without chronologically overlapping and/or chronologically spaced apart from at least one further subsection of the further process step.

In particular, the further process step has at least one subsection through which in an operating state the control unit guides, chronologically overlapping at least one subsection of the process step. The further process step could have, for example, at least one further subsection through which in an operating state the control unit could guide without chronologically overlapping and/or chronologically spaced apart from at least one further subsection of the process step.

“Designed” is intended to be understood to mean, in particular, specially programmed, configured and/or equipped. An object being designed for a specific function is intended to be understood to mean, in particular, that the object fulfills and/or executes this specific function in at least one use state and/or operating state.

The process step which is, in particular, in the form of a recipe step could comprise, for example, at least one cooking step and/or at least one food preparing step and/or at least one food addition step and/or at least one food removal step and/or at least one food processing step and/or at least one preparing step. Preferably, the process step comprises at least one heating step. For example, the process step could be in the form of a heating step. Advantageously, the process step, in particular alternatively or additionally, could have at least one further step, such as for example at least one interaction step and/or at least one confirmation step. A “heating step” is intended to be understood to mean, in particular, a process step in which in an operating state the control unit supplies energy to at least one item of cookware and/or at least one food located, in particular, in the item of cookware, in particular for the purpose of warming and/or heating and/or keeping warm the item of cookware and/or the food. In particular for the purpose of supplying energy to the item of cookware and/or to the food, in an operating state the control unit activates, in particular, at least one heating unit, in particular of the cooking appliance, and supplies energy to the object, in particular by means of the heating unit. In particular, the cooking appliance has at least one and advantageously at least the heating unit. In an operating state, the heating unit supplies, in particular as a function of an activation by the control unit, energy to the item of cookware and/or the food, in particular for the purpose of warming and/or heating and/or keeping warm the item of cookware and/or the food. As a result, in particular, a guidance through more elaborate process steps, in which for example a high risk of failure could be present, may be provided, whereby in particular a high probability of success may be possible, even of elaborate process steps.

The further process step which is, in particular, in the form of a recipe step could comprise, for example, at least one cooking step and/or at least one food preparing step and/or at least one food addition step and/or at least one food removal step and/or at least one food processing step and/or at least one preparing step. Preferably, the further process step comprises at least one heating step. For example, the further process step could be in the form of a heating step. Advantageously, the further process step could have, in particular alternatively or additionally, at least one further step, such as for example at least one interaction step and/or at least one confirmation step. As a result, in particular, a particularly high level of ease of use and/or a particularly foolproof guidance through the process may be possible.

It is further proposed that the further process step is part of the process. In particular, the further process step is part of the same process as the process step. The process step and the further process step are, in particular, part of the same process. In particular, the process has both the process step and the further process step. As a result, in particular, a particularly rapid and/or time-saving guidance through the process may be achieved, and namely in particular in comparison with a guidance through the process in which guidance takes place through all of the process steps of the process chronologically in succession.

It is further proposed that the further process step is part of at least one further process which is different from the process. In particular, the process and the further process are in the form of processes which are independent of one another and/or processes which are separate and/or discrete and/or distinct from one another. For example, the process and the further process could be of the same type. The process and the further process could be, for example, of a different type. In particular, the process and the further process are able to be executed independently of one another. The process and the further process do not overlap in terms of content in particular. Advantageously, the process and the further process may be executed in any chronological relation to one another and namely, in particular, by avoiding influencing the result to be achieved and/or by achieving the same result. As a result, in particular, it is possible to guide at least temporarily simultaneously through at least one respective part of two different processes, whereby in particular a high level of flexibility and/or a high level of ease of use may be achieved.

The further process is, in particular, in the form of a recipe and advantageously comprises the further process step which is in the form of a recipe step. For example, the process and the further process in each case could be in the form of the same recipe. Advantageously, the process and the further process are in the form of recipes which are different from one another. As a result, in particular, a preparation of two different processes may be provided to a user at least temporary simultaneously, whereby for example in the case of large celebrations, such as for example family celebrations, a rapid and/or simple preparation of different recipes may be possible.

For example, the control unit could be designed to execute the process step and the further process step at least temporarily simultaneously in different cooking appliances. In an operating state, the control unit could execute, in particular, the process step and the further process step at least temporarily simultaneously in different cooking appliances. In an operating state, the control unit could execute, for example, the process step in at least one cooking appliance which is in the form of an oven, and the further process step in at least one cooking appliance in the form of a cooktop. In particular alternatively or additionally, in an operating state the control unit could execute, for example, the process step in at least one cooking appliance which is in the form of a cooktop and the further process step in at least one cooking appliance which is in the form of an oven. Preferably, the control unit is designed to execute the process step and the further process step at least temporarily simultaneously in different zones of at least one cooking appliance. In particular in an operating state, the control unit could execute the process step and the further process step at least temporarily simultaneously in different zones of the cooking appliance. For example, in the case of a cooking appliance which is in the form of a cooktop, in an operating state the control unit could execute the process step and the further process step at least temporarily simultaneously in different heating zones, which in particular could be formed by different heating units of the cooking appliance. In particular, in the case of a cooking appliance in the form of a cooker and/or as a combined oven-cooktop appliance, in an operating state the control unit could execute, for example, a first of the process steps in a zone of the cooking appliance which is part of a baking oven of the cooking appliance, and a second of the process steps in a zone of the cooking appliance which is part of a cooktop of the cooking appliance. As a result, for the at least temporarily simultaneous guidance through the process step and the further process step, in particular, further cooking appliances may be dispensed with, whereby in particular a guidance which is cost-effective and/or clear may be possible.

It is further proposed that the control unit is designed to coordinate the process step and the further process step, in particular chronologically with one another, and during the coordination, in particular, to consider at least one coordination parameter. In an operating state, the control unit coordinates, in particular, the process step and the further process step, in particular chronologically to one another and considers at least one coordination parameter, in particular during the coordination. In particular, the coordination parameter could comprise at least one time parameter and/or be in the form of a time parameter. The coordination parameter could comprise, for example, at least one start and/or at least one end of the process step and/or the further process step. For example, in an operating state, the control unit could coordinate at least one start of the process step and of the further process step, in particular chronologically with one another, and in particular start the process step and the further process step at least substantially simultaneously, and advantageously simultaneously. In an operating state, the control unit could coordinate, for example, at least one end of the process step and of the further process step, in particular chronologically with one another, and in particular terminate the process step and the further process step at least substantially simultaneously, and advantageously simultaneously. The coordination parameter could comprise, for example, at least one time of at least one user interaction to be performed in the process step and/or at least one time of at least one user interaction to be performed in the further process step. In an operating state, the control unit could coordinate, for example, the user interactions to be performed in the process steps, in particular chronologically, with one another and time and/or arrange these user interactions, in particular chronologically spaced apart from one another, in order to permit a user thereby, in particular, an at least temporarily simultaneous guidance through the process steps. The expression that the control unit is designed to “coordinate with one another” the process step and the further process step is intended to be understood to mean, in particular, that in an operating state the control unit coordinates the process steps via an at least temporarily simultaneous arrangement of the process steps, in particular chronologically with one another. As a result, in particular, a particularly simple and/or stress-free guidance through the process and/or through the further process may be provided, in particular for a user, since by clever coordination of the process steps with one another, for example, tasks to be completed and/or user interactions could be arranged chronologically optimized relative to one another.

For example, during the coordination, the control unit could set a sufficient time interval of user interactions to be performed in the process steps. Preferably, during the coordination, the control unit is designed to set an at least substantially simultaneous target completion of the process step and the further process step. In particular, during the coordination, the control unit sets an at least substantially simultaneous target completion of the process step and the further process step. The control unit is designed, in particular as a function of at least one target completion of the process steps, in particular of the process step and the further process step, and, by considering at least one respective process step duration to be anticipated of the process steps, to time the process steps relative to one another. In particular, during the coordination, the control unit sets an at least substantially simultaneous and advantageously simultaneous target completion of the process step and of the further process step. As a result, in particular, in the case of a process with at least two different components, a simultaneous target completion of the components may be possible, whereby in particular keeping individual components warm may be dispensed with and/or the components may be served directly after completion.

It is further proposed that the control unit is designed to assign to the process steps at least one value of at least one simultaneity parameter which characterizes at least one suitability for an at least temporarily simultaneous guidance through the process steps, and to select, as a function of the value of the simultaneity parameter, the process steps through which the control unit at least temporarily simultaneously guides. In particular, in an operating state, the control unit assigns to the process steps at least one value of at least one simultaneity parameter and selects, in particular as a function of the value of the simultaneity parameter, the process steps through which the control unit at least temporarily simultaneously guides. The simultaneity parameter characterizes, in particular, at least one suitability of at least one process step for an at least temporarily simultaneous guidance through the process steps. For example, the simultaneity parameter could comprise at least one time parameter. The simultaneity parameter, in particular comprising the time parameter, could comprise, for example, at least one length of time of a process step and/or at least one process step duration of a process step. The simultaneity parameter could comprise, for example, at least one availability parameter. The simultaneity parameter comprising, in particular, the availability parameter could comprise, for example, at least one available sensor unit which could be designed, for example, for a detection of at least one temperature variable and/or at least one weight variable and/or at least one cooking state. For example, the simultaneity parameter comprising, in particular, the availability parameter could comprise at least one available cooking appliance and/or at least one available food processing appliance and/or at least one available household appliance. The simultaneity parameter comprising, in particular, the availability parameter could comprise, for example, at least one available power for heating and/or at least one number of available heating zones and/or at least one number of free heating zones and/or a category of available food and/or a type of available food. The simultaneity parameter could comprise, for example, at least one execution parameter. The simultaneity parameter comprising the execution parameter in particular could comprise, for example, at least one variable of at least one item of cookware recommended for the guidance and/or at least one diameter of at least one item of cookware recommended for the guidance. For example, the simultaneity parameter comprising, in particular, the execution parameter could comprise at least one number of user interactions and/or a complexity of at least one user interaction and/or a required level of action of a user. The simultaneity parameter comprising, in particular, the execution parameter could comprise, for example, a category and/or a type of process through which the control unit is intended to guide. For example, the simultaneity parameter comprising, in particular, the execution parameter could comprise at least one quantity of at least one food and/or at least a number of foods required. As a result, in particular, an optimized, at least temporarily simultaneous, guidance may be achieved, whereby in particular, a particularly high level of ease of use may be provided.

For example, in an operating state, the control unit could select, as a function of the simultaneity parameter, at least one process which comprises process steps with a long process duration and/or which comprises process steps with a reduced number of user interactions and/or which comprises process steps with a reduced complexity of user interactions. In an operating state, the control unit could select, in particular as a function of the simultaneity parameter, at least one process which comprises at least one process step with a long heating up duration, for example due to a greater quantity of water and/or oil and/or which comprises at least one process step with a long heating duration and/or cooking duration. For example, in an operating state, the control unit could avoid and/or defer, as a function of the simultaneity parameter, at least one process which comprises at least one process step with time-consuming user interactions, such as for example continuous stirring and/or frying of a large number of, in particular, small separate foods.

It is further proposed that the simultaneity parameter comprises at least one current availability parameter, in particular of at least one food preparation component, which could define and/or characterize, for example, at least one availability which is current and/or which is present at a given time and/or which is present in a given situation, in particular of at least one food preparation component. The food preparation component could be, for example, at least one sensor unit and/or at least one, in particular free, heating zone and/or at least one food processing implement and/or at least one kitchen appliance and/or at least one household appliance and/or at least one cooking appliance. As a result, in particular, a seamless guidance may be guaranteed, whereby in particular a user could be spared inconvenience arising during the guidance, which could be caused, for example, by an unavailability of the food preparation component.

For example, in an operating state, the control unit could select, in particular exclusively as a function of the simultaneity parameter, the process steps through which the control unit at least temporarily simultaneously guides. Preferably, the control unit is designed to consider, chronologically before an at least temporarily simultaneous guidance through the process steps, at least one user-related individual parameter and to select, as a function of the user-related individual parameter, the process steps through which the control unit at least temporarily simultaneously guides. In particular, the control unit considers at least one user-related individual parameter chronologically before an at least temporarily simultaneous guidance through the process steps and selects in particular, as a function of the user-related individual parameter, the process steps through which the control unit at least temporarily simultaneously guides. As a result, individual and/or personal requirements of a user may be addressed, whereby in particular an adaptation of the process which is tailored to the user may be possible.

For example, the user-related individual parameter could comprise at least one individual capability parameter, in particular of a user, which could define and/or characterize, for example, at least one individual capability and/or at least one individual degree of experience, in particular of the user. The user-related individual parameter could comprise, in particular alternatively or additionally, for example, at least one individual environmental parameter which could define and/or characterize, for example, at least one individual environmental situation and/or at least one individual everyday situation, in particular of the user. Preferably, the user-related individual parameter comprises at least one individual time parameter, in particular of a user. The individual time parameter could define and/or characterize, for example, at least one time which is available individually and/or at a given time and/or in a given situation, in particular of the user. As a result, in particular during the guidance, a time available to a user during the guidance may be considered, whereby advantageously a flexible adaptation of the guidance is possible and a guidance may be possible for a user irrespective of the time available thereto.

It is further proposed that the food preparation system has at least one cooking appliance and, in particular, at least one cooktop in which at least the control unit is at least partially integrated, in particular is integrated at least to a large part and advantageously is integrated. The expression that a first object is “at least partially” integrated in at least one second object is intended to be understood to mean, in particular, that the first object has at least one partial object which is integrated in the second object, and for example could have at least one further partial object which could be arranged outside the second object and/or which could be integrated in at least one third object which is different from the second object. “At least to a large part” is intended to be understood to mean, in particular, by a proportion, in particular a mass proportion and/or a volume proportion of at least 70%, in particular of at least 80%, advantageously of at least 90% and preferably of at least 95%. As a result, in particular, a reduced stock-keeping and/or a small variety of components may be achieved.

A particularly high level of ease of use may be achieved, in particular, by a cooking appliance, in particular by a cooktop of a food preparation system according to the invention.

An ease of use may be further increased, in particular, by a method for an operation of a food preparation system according to the invention, in which guidance takes place through at least one process step of at least one process which is in the form of a recipe and comprises the process step in the form of a recipe step, in particular via at least one output unit of the food preparation system, wherein the guidance takes place at least temporarily simultaneously through the process step and at least one further process step which is in the form of a recipe step.

In this case, the food preparation system is not intended to be limited to the above-described use and embodiment. In particular, the food preparation system may have a number of individual elements, components and units which is different from a number mentioned herein in order to fulfill a functionality described herein.

Further advantages emerge from the following description of the drawing. Exemplary embodiments of the invention are shown in the drawing. The drawing, the description and the claims contain numerous features in combination. The person skilled in the art will also expediently consider the features individually and combine them to form further meaningful combinations.

In the drawing:

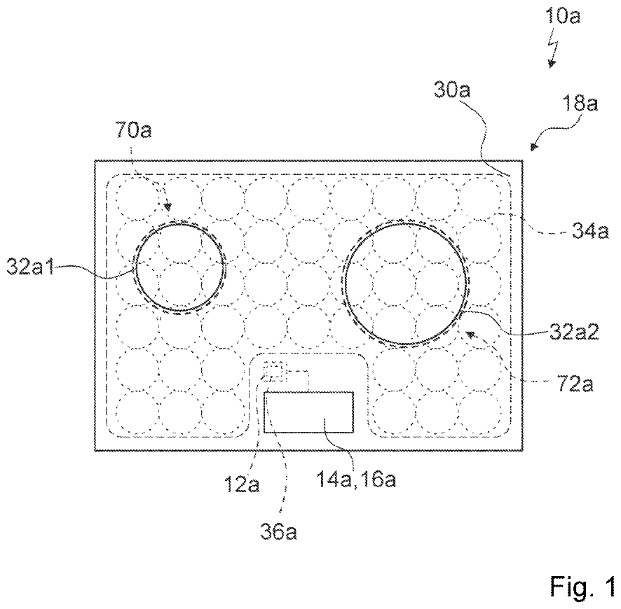

FIG. 1 shows a food preparation system in a schematic plan view,

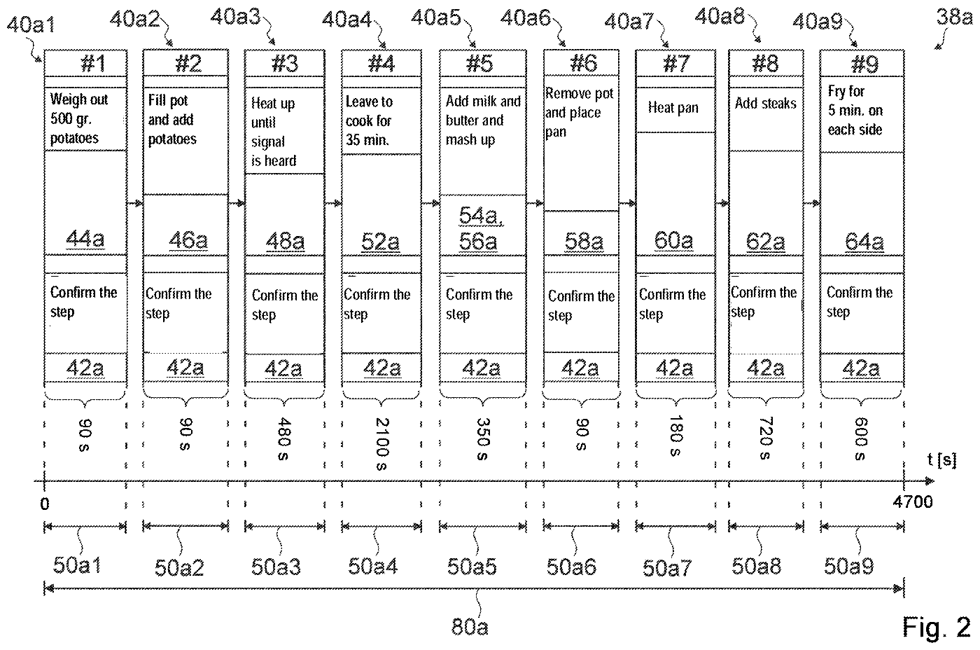

FIG. 2 shows a diagram in which an exemplary process is shown with process steps arranged chronologically in succession, in a schematic view,

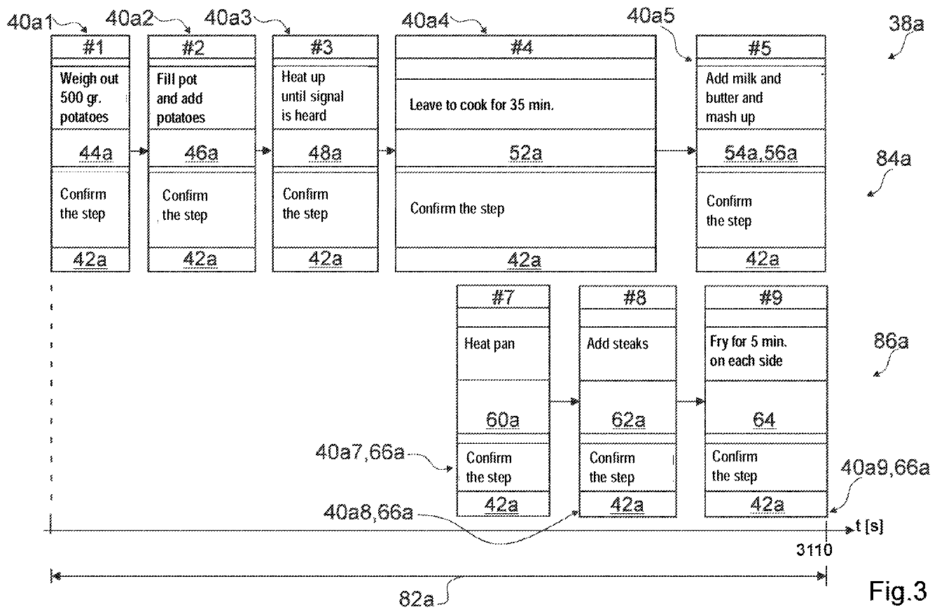

FIG. 3 shows a diagram in which the exemplary process is shown with process steps partially chronologically overlapping, in a schematic view,

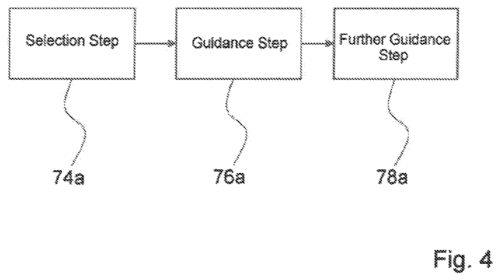

FIG. 4 shows a diagram of a method for an operation of the food preparation system, in a schematic view, and

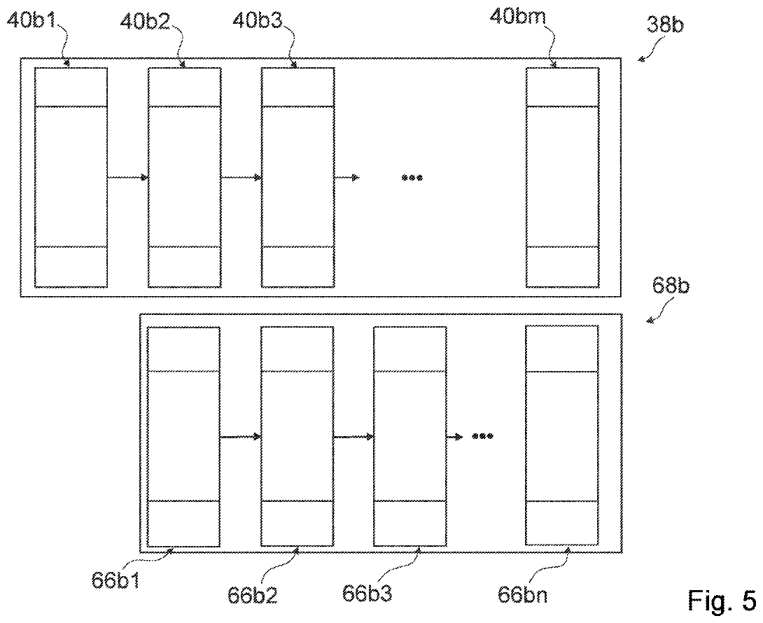

FIG. 5 shows a diagram in which two exemplary processes are shown with process steps partially chronologically overlapping, in a schematic view.

FIG. 1 shows by way of example a food preparation system 10a. The food preparation system 10a could be in the form of, for example, a cooking system and, in particular, an induction cooking system. For example, the food preparation system 10a could be in the form of a cooktop-type cooking system and, in particular, an induction cooktop-type cooking system.

The food preparation system 10a has, in particular, at least one and advantageously exactly one cooking appliance 18a. The cooking appliance 18a could be, for example, at least one oven, such as for example a cooker and/or a baking oven. In particular, alternatively or additionally, the cooking appliance 18a could be, for example, a microwave appliance and/or a grill appliance and/or a steamer. Advantageously, in the present exemplary embodiment the cooking appliance 18a is a cooktop. The cooking appliance 18a is, in particular, an induction cooking appliance. In the present exemplary embodiment, the cooking appliance 18a is, in particular, an induction cooktop.

In particular, the cooking appliance 18a is suitable specifically for the food preparation system 10a and, in particular, adapted specifically to the food preparation system 10a. The cooking appliance 18a is designed, in particular, specifically for the food preparation system 10a.

The cooking appliance 18a has, in particular, at least one and advantageously exactly one appliance plate 30a. The appliance plate 30a is in the form of, in particular, a positioning plate and advantageously a cooktop plate. In a mounted state, the appliance plate 30a forms, in particular, a part of an appliance external housing, in particular of a cooktop external housing, advantageously of the cooking appliance 18a. The appliance plate 30a is designed, in particular, for positioning an item of cookware 32a.

The food preparation system 10a has, in particular, at least one heating unit 34a. Advantageously, the food preparation system 10a has at least two, in particular at least four, advantageously at least eight, particularly advantageously at least twelve, preferably at least fifteen and particularly preferably a plurality of heating units 34a. In the present exemplary embodiment, by way of example the food preparation system 10a has forty-eight heating units 34a. Of the objects which are repeatedly present, in each case only one is provided with a reference numeral in the figures.

For example, alternatively, the food preparation system 10a could have, in particular, a smaller number of heating units 34a. For example, the food preparation system 10a could have two, in particular three, advantageously four, particularly advantageously five and preferably six heating units 34a.

For example, the heating units 34a could be arranged in the form of a conventional cooktop, in which at least some of the heating units 34a could form, in particular, separate heating zones. Advantageously, at least some of the heating units 34a could be arranged in the form of a matrix and, in particular, combined to form a flexible definition and/or formation of heating zones, in particular by at least one control unit 12a. Hereinafter, only one of the heating units 34a is described by way of example.

In particular, in an installed position the heating unit 34a is arranged on a side of the appliance plate 30a facing away from a user. In particular, in an installed position the heating unit 34a is arranged below the appliance plate 30a. In a mounted state, the heating unit 34a is integrated, in particular at least partially and advantageously at least to a large part, in the cooking appliance 18a, in particular in the cooktop. The heating unit 34a is designed, in particular, to heat an item of cookware 32a positioned on the appliance plate 30a above the heating unit 34a. The heating unit 34a is, in particular, part of the cooking appliance 18a, in particular of the cooktop. The cooking appliance 18a, in particular the cooktop, has in particular the heating unit 34a.

The food preparation system 10a has, in particular, at least one and advantageously exactly one user interface 14a. The user interface 14a is designed, in particular, for an input and/or selection of operating parameters, such as for example a heating power and/or a heating power density and/or a heating zone. The user interface 14a is designed, in particular, for an output of a value of an operating parameter to a user. In a mounted state, the user interface 14a is integrated, in particular at least partially and advantageously at least to a large part, in the cooking appliance 18a, in particular in the cooktop. The cooking appliance 18a, in particular the cooktop, has in particular the user interface 14a.

The food preparation system 10a has, in particular, at least one and advantageously exactly one output unit 16a. The output unit 16a is configured, in particular, at least partially integrally with the user interface 14a. In particular, the output unit 16a is part of the user interface 14a. The user interface 14a has, in particular, the output unit 16a.

The expression that a first object and a second object are configured “at least partially integrally” with one another is intended to be understood to mean, in particular, that the first object has at least one element which is also part of the second object and/or that the second object has at least one element which is also part of the first object. In particular, the user interface 14a and the output unit 16a in each case have at least one, in particular at least two, advantageously at least three, common elements which are a component, in particular a functionally important component, both of the user interface 14a and of the output unit 16a.

In particular, the output unit 16a is designed, in particular, for an optical output to a user. In particular, alternatively or additionally, the output unit 16a could be designed, for example, for an acoustic output to a user.

In a mounted state, the output unit 16a is integrated, in particular at least partially and advantageously at least to a large part, in the cooking appliance 18a, in particular in the cooktop. The output unit 16a, in particular, is part of the cooking appliance 18a, in particular of the cooktop. In particular, the cooking appliance 18a, in particular the cooktop, has the output unit 16a.

In particular, alternatively or additionally, the output unit 16a and/or the user interface 14a, for example, could be partially integrated in the cooking appliance 18a and, in particular, partially in at least one mobile device of the food preparation system 10a. The output unit 16a and/or the user interface 14a could be integrated, in particular alternatively or additionally, in particular at least partially, advantageously at least to a large part and preferably entirely, in at least one mobile device of the food preparation system 10a.

The food preparation system 10a has, in particular, at least one and advantageously exactly one control unit 12a, in particular at least the and advantageously exactly the control unit 12a. The control unit 12a is designed, in particular, to execute actions and/or to change settings as a function of operating parameters input by means of the user interface 14a. In a heating operating state, the control unit 12a regulates, in particular, an energy supply to the heating unit 34a. In a mounted state, in particular, the control unit 12a is integrated at least partially and advantageously at least to a large part in the cooking appliance 18a, in particular in the cooktop. The cooking appliance 18a, in particular the cooktop, has in particular the control unit 12a.

The control unit 12a is designed, in particular, to control and/or regulate at least the user interface 14a and/or the output unit 16a. In an operating state, the control unit 16a controls and/or regulates, in particular, the user interface 14a and/or the output unit 16a. For example, only the user interface 14a is mentioned hereinafter as representative of the expression “user interface 14a and/or output unit 16a”.

The control unit 12a is designed to guide through at least one process step 40a of at least one process 38a, in particular via the user interface 14a (see FIGS. 2 to 4). In an operating state, the control unit 12a guides, in particular via the user interface 14a, in particular through at least one process step 40a of at least one process 38a, and namely in particular as a function of a selection of the process 38a by at least one user input.

The process 38a is particularly advantageously in the form of a recipe. In particular, the process 38a comprises at least the process step 40a. The process 38a comprises, in particular, at least the process step 40a which is in the form of a recipe step.

The control unit 12a has in particular at least one memory unit 36a. The process 38a is stored, in particular, in the memory unit 36a. Advantageously, a plurality of processes 38a are stored in the memory unit 36a, in particular with the process steps 40a belonging to the respective process 38a.

The process 38a has, in particular, a plurality of process steps 40a. In the present exemplary embodiment, the process 38a has by way of example nine process steps 40a. In the present exemplary embodiment, the process 38a comprises by way of example a recipe for a preparation of a dish denoted as “steak with mashed potato”.

FIG. 2 shows the process 38a with process steps 40a arranged without chronologically overlapping and in a chronological sequence one after the other. Additionally in FIG. 2 a time specification which is, in particular, to be anticipated and/or roughly estimated and which specifies, in particular, a total duration of the respective process step 40a, is specified by way of example for each process step 40a of the process 38a.

In particular, individual process steps 40a of the process 38a are described briefly hereinafter in chronological sequence. In this case, in particular, a number which represents a number of the respective process step 40a is added to the reference numeral of the respective process step 40a.

In particular, at least a part of, advantageously at least a large part of, and particularly advantageously each of the process steps 40a has at least one and advantageously exactly one confirmation step 42a which is designed, in particular, to complete the corresponding process step 40a. The control unit 12a, in particular during the guidance, outputs at least one operating request in the corresponding confirmation step 42, in particular for terminating the process step 40a, advantageously by means of the user interface 14a. In particular, in an operating state, the control unit 12a terminates a corresponding process step 40a as a function of at least one user input, in particular by means of the user interface 14a, in the confirmation step 42a.

The process 38a has, in particular, at least one and advantageously exactly one first process step 40a1. The, in particular first, process step 40a1 comprises, in particular, at least one food preparing step 44a which is in particular in the form of a weighing step, and which comprises in particular at least a weighing out of at least one food, in particular in the form of potatoes. In particular, the in particular first process step 40a1 comprises the confirmation step 42a. The in particular first process step 40a1 has, in particular, an in particular first process step duration 50a1 of at least substantially 90 s.

The process 38a has, in particular, at least one and advantageously exactly one second process step 40a2. The in particular second process step 40a2 comprises, in particular, at least one food addition step 46a which comprises in particular an addition of the food, in particular in the form of potatoes, into at least one, in particular first, item of cookware 32a1. In particular, the in particular second process step 40a2 comprises the confirmation step 42a. The in particular second process step 40a2 has, in particular, an in particular second process step duration 50a2 of at least substantially 90 s.

The process 38a has, in particular, at least one and advantageously exactly one third process step 40a3. The in particular third process step 40a3 comprises, in particular, at least one heating up step 48a which comprises in particular a heating up of the, in particular first, item of cookware 32a1 and/or the food located in the, in particular first, item of cookware 32a1. In particular, the in particular third process step 40a3 comprises the confirmation step 42a. The in particular third process step 40a3 has, in particular, an in particular third process step duration 50a3 of at least substantially 480 s.

The process 38a has, in particular, at least one and advantageously exactly one fourth process step 40a4. The in particular fourth process step 40a4 comprises, in particular, at least one heating step 52a which comprises in particular a heating of the, in particular first, item of cookware 32a1 and/or the food located in the, in particular first, item of cookware 32a1. In particular, the in particular fourth process step 40a4 comprises the confirmation step 42a. The in particular fourth process step 40a4 has, in particular, an in particular fourth process step duration 50a4 of at least substantially 2100 s.

The process 38a has, in particular, at least one and advantageously exactly one fifth process step 40a5. The in particular fifth process step 40a5 comprises, in particular, at least one food addition step 54a which comprises, in particular, an addition of a food, in particular in the form of milk and butter into the, in particular first, item of cookware 32a1 and comprises, in particular, at least one food processing step 56a which comprises in particular at least one processing of food located, in particular, in the in particular first item of cookware 32a1. In particular, the in particular fifth process step 40a5 comprises the confirmation step 42a. The in particular fifth process step 40a5 has, in particular, an in particular fifth process step duration 50a5 of at least substantially 350 s.

The process 38a has, in particular, at least one and advantageously exactly one sixth process step 40a6. The in particular sixth process step 40a6 comprises, in particular, at least one preparing step 58a which comprises, in particular, at least one removal of the, in particular first, item of cookware 32a1 and, in particular, at least one arrangement of at least one, in particular second, item of cookware 32a2. In particular, the in particular sixth process step 40a6 comprises the confirmation step 42a. The in particular sixth process step 40a6 has, in particular, an in particular sixth process step duration 50a6 of at least substantially 90 s.

The process 38a has, in particular, at least one and advantageously exactly one seventh process step 40a7. The in particular seventh process step 40a7 comprises, in particular, at least one heating up step 60a which comprises, in particular, at least one heating up of the, in particular second, item of cookware 32a2 and/or of the food located in the, in particular second, item of cookware 32a2. In particular, the in particular seventh process step 40a7 comprises the confirmation step 42a. The in particular seventh process step 40a7 has, in particular, an in particular seventh process step duration 50a7 of at least substantially 180 s.

The process 38a has, in particular, at least one and advantageously exactly one eighth process step 40a8. The in particular eighth process step 40a8 comprises, in particular, at least one food addition step 62a which comprises, in particular, an addition of a food, in particular in the form of at least one steak, in at least one, in particular second, item of cookware 32a2. In particular, the in particular eighth process step 40a8 comprises the confirmation step 42a. The in particular eighth process step 40a8 has, in particular, an in particular eighth process step duration 50a8 of at least substantially 180 s.

The process 38a has, in particular, at least one and advantageously exactly one ninth process step 40a9. The in particular ninth process step 40a9 comprises, in particular, at least one heating step 64a which comprises, in particular, a heating of the, in particular second, item of cookware 32a2 and/or of the food located in the, in particular second, item of cookware 32a2. In particular, the in particular ninth process step 40a9 comprises the confirmation step 42a. The in particular ninth process step 40a9 has, in particular, an in particular ninth process step duration 50a9 of substantially 600 s.

The process step 40a of the process 38a, through which the control unit 12a guides in an operating state, is described by way of example hereinafter. Particularly advantageously, the control unit 12a is designed to guide at least temporarily simultaneously through the process step 40a and at least one further process step 66a (see FIG. 3). In an operating state, the control unit 12a guides at least temporarily simultaneously through the process step 40a and at least one further process step 66a.

The process step 40a and the further process step 66a are configured, in particular, differently from one another. In particular, the process step 40a and the further process step 66a are configured discretely and/or separately from one another.

In the present exemplary embodiment, the process step 40a comprises, in particular, at least one heating step. For example, the process step 40a could be the in particular fourth process step 40a4 and/or the in particular ninth process step 40a9.

The further process step 66a is, in particular, in the form of a recipe step. For example, the further process step 66a could comprise at least one heating up step and/or at least one preparing step and/or at least one food preparing step and/or at least one food addition step. Advantageously, the further process step 66a comprises, in particular, at least one heating step.

For example, the further process step 66a could be part of at least one further process which is different from the process 38a. In the present exemplary embodiment, the further process step 66a is, in particular, part of the process 38a which has, in particular, the process step 40a. In particular, the process step 40a and the further process step 66a are part of the same process 38a.

For example, the further process step 66a could be the in particular ninth process step 40a9 and/or the in particular fourth process step 40a4. Hereinafter, by way of example without limiting the generality, it might be assumed that the process step 40a is the in particular fourth process step 40a4 and the further process step 66a is the in particular ninth process step 40a9.

In particular, during the at least temporarily simultaneous guidance, the control unit 12a is designed to execute, in particular, the process step 40a and the further process step 66a at least temporarily simultaneously in different zones 70a, 72a of the cooking appliance 18a. In an operating state, the control unit 12a executes the process step 40a and the further process step 66a at least temporarily simultaneously in different zones 70a, 72a of the cooking appliance 18a.

In particular, the cooking appliance 18a has at least the zones 70a, 72a. The zones 70a, 72a are configured, in particular, as heating zones. The cooking appliance 18a has, in particular, one zone 70a of the zones 70a, 72a which is in the form of a heating zone in particular. In particular, the control unit 12a is designed for heating the in particular first item of cookware 32a1 by means of the zone 70a. In an operating state, the control unit 12a heats the in particular first item of cookware 32a1 by means of the zone 70a.

The cooking appliance 18a has, in particular, a further zone 72a of the zones 70a, 72a which is, in particular, in the form of a heating zone. In particular, the control unit 12a is designed for heating the in particular second item of cookware 32a2 by means of the further zone 72a. In an operating state, the control unit 12a heats the in particular second item of cookware 32a2 by means of the further zone 72a.

The control unit 12a is designed to coordinate the process step 40a and the further process step 66a, in particular chronologically with one another. In particular, in an operating state the control unit 12a coordinates the process step 38a and the further process step 66a, in particular chronologically with one another. During the coordination, the control unit 12a considers, in particular, at least one coordination parameter. In the present exemplary embodiment, the coordination parameter is in the form of, in particular, a time parameter.

In particular, during the coordination, the control unit is designed to set an at least substantially simultaneous target completion of the process step 40a and the further process step 66a. In an operating state, in particular during the coordination, the control unit 12a sets an at least substantially simultaneous target completion of the process step 40a and the further process step 66a. Advantageously, in an operating state, by means of the target completion the control unit 12a sets an at least substantially simultaneous end of the process step 40a and the further process step 66a.

The control unit 12a is designed, in particular, to assign to the process steps 40a, 66a, in particular the process step 40a and the further process step 66a, in particular in each case, at least one value of at least one simultaneity parameter. In an operating state, the control unit 12a assigns to the process steps 40a, 66a, in particular the process step 40a and the further process step 66a, in each case in particular at least one value of at least one simultaneity parameter.

The simultaneity parameter characterizes, in particular, at least one suitability for an at least temporarily simultaneous guidance through the process steps 40a, 66a, in particular through the process step 40a and through the further process step 66a.

For example, the simultaneity parameter could have at least one time parameter which could comprise, in particular, at least one time duration of the process steps 40a, 66a, in particular of the process step 40a and the further process step 66a.

Advantageously, in the present exemplary embodiment the simultaneity parameter comprises, in particular in addition to the time parameter of the simultaneity parameter, at least one current availability parameter, in particular of at least one food preparation component. The simultaneity parameter comprising, in particular, the current availability parameter defines and/or characterizes, for example, at least one availability which is current and/or present at a given time and/or in a given situation, in particular of the food preparation component. The food preparation component could be, for example, at least one sensor unit and/or at least one, in particular free, heating zone and/or at least one free zone 70a, 72a of the cooking appliance 18a.

The control unit 12a is designed, in particular, to select as a function of the value of the simultaneity parameter the process steps 40a, 66a through which the control unit 12a at least temporarily simultaneously guides. In an operating state, the control unit 12a selects, in particular as a function of the value of the simultaneity parameter, the process steps 40a, 66a through which the control unit 12a at least temporarily simultaneously guides.

In the present exemplary embodiment, in an operating state, the control unit 12a selects, in particular as a function of the value of the simultaneity parameter, in particular the process step 40a and the further process step 66a, and in particular in an operating state guides at least temporarily simultaneously through the selected process steps 40a, 66a.

In particular, the control unit 12a is designed to consider at least one user-related individual parameter chronologically before an at least temporarily simultaneous guidance through the process steps 40a, 66a. In an operating state, the control unit 12a considers at least one user-related individual parameter, in particular chronologically before the at least temporarily simultaneous guidance through the process steps 40a, 66a.

The user-related individual parameter could comprise, for example, at least one individual capability parameter and/or at least one individual environmental parameter. In the present exemplary embodiment, the user-related individual parameter comprises, in particular, at least one individual time parameter. The individual time parameter could define and/or characterize, for example, at least one individually available time, in particular of the user. For example, the individual time parameter could adopt a value which could be denoted as “in a hurry” and/or “sufficient time” and/or “average time availability” and/or “willing to learn” and/or “plenty of time”.

The control unit 12a is designed, in particular, to select as a function of the user-related individual parameter the process steps 40a, 66a through which the control unit 12a at least temporarily simultaneously guides. In an operating state, the control unit 12a selects, in particular as a function of the user-related individual parameter, the process steps 40a, 66a through which the control unit 12a at least temporarily simultaneously guides.

During the selection of the process steps 40a, 66a through which the control unit 12a at least temporarily simultaneously guides, the control unit 12a considers, in particular, both the simultaneity parameter and the user-related individual parameter. In particular, during the selection of the process steps 40a, 66a the control unit 12a weights the simultaneity parameter and the user-related individual parameter in particular relative to one another and, in particular, relative to an importance and/or urgency and/or a possible combination.

In a method for an operation of the food preparation system 10a, in particular in at least one selection step 74a, the process 38a is selected, in particular, from a plurality of processes 38a stored in the memory unit 36a (see FIG. 4). Guidance takes place, in particular, in at least one guidance step 76a, in particular through the process 38a, in particular at least one process step 40a, 66a of the process 38a, which is in the form of a recipe and comprises the process step 40a, 66a in the form of a recipe step.

Guidance takes place, in particular, in at least one further guidance step 78a, in particular through the further process step 66a which is in the form of a recipe step and which in particular is part of the same process 38a, at least temporarily simultaneously with the process step 40a.

In particular, a comparison of FIGS. 2 and 3 is to be considered hereinafter. In particular in the case of an execution without chronologically overlapping and/or in the case of an execution of the process steps 40a of the process 38a in a chronological sequence one after the other, the process 38a has a total process duration 80a of at least substantially 4700 s (see FIG. 2). In particular, in the case of an at least temporarily simultaneous guidance through process steps 40a, 66a of the process 38a, the process 38a has, in particular, a total process duration 82a of at least substantially 3110 s (see FIG. 3).

In an operating state, the control unit 12a divides the process 38a, in particular, into at least two and advantageously exactly two subprocesses 84a, 86a. In an operating state, the control unit 12a executes the subprocesses 84a, 86a at least temporarily simultaneously. In particular, due to the at least temporarily simultaneous guidance through process steps 40a, 66a of the process 38a and/or through the subprocesses 84a, 86a of the process 38a, during the guidance through the process 38a the control unit 12a deletes at least one and advantageously exactly one process step 40a6 from the process, since in particular due to the at least temporarily simultaneous execution in different zones 70a, 72a of the cooking appliance 18a, this process step 40a6 is superfluous.

In particular, the subprocess 84a of the subprocesses 84a, 86a comprises the process steps 40a having the numbers one to five. A further subprocess 86a of the subprocesses 84a, 86a comprises, in particular, the process steps 40a having the numbers seven to nine. In particular, in an operating state the control unit 12a deletes the process step 40a having the number six.

A further exemplary embodiment of the invention is shown in FIG. 5. The following descriptions are substantially limited to the differences between the exemplary embodiments, wherein relative to components, features and functions remaining the same, reference may be made to the description of the exemplary embodiment of FIGS. 1 to 4. In order to differentiate between the exemplary embodiments, the letter a in the reference numerals of the exemplary embodiment of FIGS. 1 to 4 is replaced by the letter b in the reference numerals of the exemplary embodiment of FIG. 5. Relative to components denoted the same, in particular relative to components having the same reference numerals, in principle reference may also be made to the drawing and/or the description of the exemplary embodiment of FIGS. 1 to 4.

An alternative food preparation system 10b is shown in FIG. 5. In an operating state, a control unit 12b of the food preparation system 10b guides through at least one further process step 66b, in particular at least temporarily simultaneously with at least one process step 40b of at least one process 38b. The process 38b is, in particular, in the form of a recipe. The process step 40b is, in particular, in the form of a recipe step. In particular, the process 38b comprises the process step 40b.

In the present exemplary embodiment, the further process step 66b is, in particular, part of at least one further process 68b which is different from the process 38b. The process 38b and the further process 68b are different and/or discrete and/or separate from one another. In the present exemplary embodiment, the further process 68b is, in particular, in the form of a recipe. In particular, the further process step 66b is in the form of a recipe step. The further process 68b comprises, in particular, the further process step 68b in the form of a recipe step.

### REFERENCE NUMERALS

10 Food preparation system
12 Control unit
14 User interface
16 Output unit
18 Cooking appliance
30 Appliance plate
32 Item of cookware
34 Heating unit
36 Memory unit
38 Process
40 Process step
42 Confirmation step
44 Food preparing step
46 Food addition step
48 Heating up step
50 Process step duration
52 Heating step
54 Food addition step
56 Food processing step
58 Preparing step
60 Heating up step
62 Food addition step
64 Heating step
66 Further process step
68 Further process
70 Zone
72 Further zone
74 Selection step
76 Guidance step
78 Further guidance step
80 Total process duration
82 Total process duration
84 Subprocess
86 Further subprocess

1.-15. (canceled)

16. A food preparation system, comprising a control unit designed to guide through a process step of a process, which is in the form of a recipe and comprises the process step in the form of a recipe step, said control unit being designed to guide at least temporarily simultaneously to the process step at least one further process step, which is in the form of a recipe step.

17. The food preparation system of claim 16, wherein the process step comprises a heating step.

18. The food preparation system of claim 16, wherein the further process step comprises a heating step.

19. The food preparation system of claim 16, wherein the further process step is part of the process.

20. The food preparation system of claim 16, wherein the further process step is part of a further process which is different from the process.

21. The food preparation system of claim 16, further comprising a cooking appliance, said control unit being designed to execute the process step and the further process step at least temporarily simultaneously in different zones of the cooking appliance.

22. The food preparation system of claim 16, wherein the control unit is designed to coordinate the process step and the further process step with one another.

23. The food preparation system of claim 22, wherein, during coordination of the process step and the further process step with one another, the control unit is designed to set an at least substantially simultaneous target completion of the process step and the further process step.

24. The food preparation system of claim 16, wherein the control unit is designed to assign to the process steps a value of a simultaneity parameter which characterizes a suitability for an at least temporarily simultaneous guidance through the process step and the further process step, and to select, as a function of the value of the simultaneity parameter, the process step and the further process step through which the control unit at least temporarily simultaneously guides.

25. The food preparation system of claim 24, wherein the simultaneity parameter comprises a current availability parameter.

26. The food preparation system of claim 16, wherein the control unit is designed to consider, chronologically before a temporarily simultaneous guidance through the process step and the further process step, a user-related individual parameter and to select, as a function of the user-related individual parameter, the process step and the further process step through which the control unit at least temporarily simultaneously guides.

27. The food preparation system of claim 26, wherein the user-related individual parameter comprises an individual time parameter.

28. The food preparation system of claim 16, further comprising a cooking appliance, said control unit being at least partially integrated in the cooking appliance.

29. A cooking appliance of a food preparation system comprising a control unit that is at least partially integrated in the cooking appliance and designed to guide through a process step of a process, which is in the form of a recipe and comprises the process step in the form of a recipe step, said control unit being designed to guide at least temporarily simultaneously to the process step at least one further process step, which is in the form of a recipe step.

30. A cooking appliance of claim 29, constructed in the form of a cooktop.

31. A method for operating a food preparation system, said method comprising:
guiding with a control unit through a process step of a process which is in the form of a recipe and comprises the process step in the form of a recipe step; and
guiding with the control unit at least temporarily simultaneously to the process step a further process step which is in the form of a recipe step.
